(19) United States
(12) Patent Application Publication
(10) Pub. No.: US 2026/0254018 A1
(43) Pub. Date: Aug. 27, 2026

(54) HOUSING DEVICE AND METHOD

(71) Applicant: Siemens Energy AS, Oslo (NO)

(72) Inventor: Arve Skjetne, Trondheim (NO)

(21) Appl. No.: 18/995,344

(22) PCT Filed: Jul. 20, 2023
(86) PCT No.: PCT/EP2023/070138

§ 371 Date: Jan. 16, 2025

(30) Foreign Application Priority Data
Jul. 27, 2022 (GB) 2210940.9

(51) Int. Cl. H01M 50/227; H01G 11/80; H01M 10/613; H01M 10/647; H01M 10/6568; H01M 50/209; H01M 50/211

(52) U.S. Cl. CPC H01M 50/227; H01M 10/613; H01M 10/647; H01M 10/6568; H01M 50/209; H01M 50/211; H01G 11/80

(57) ABSTRACT

A welded polymer plastic, composite or thermoplastic housing having at least two injection moulded polymer plastic, composite or thermoplastic housing parts. The housing parts including a perimeter and a thermoplastic film sandwiched between contact surfaces of the perimeters of the at least two housing parts. The contact surfaces of the at least two housing parts and the sandwiched thermoplastic film form a weld seal between the two housing parts.

### BACKGROUND

This invention relates to a housing including a cooling device for an energy storage module and associated method of manufacture, in particular for a module for storing electrical energy, such as an electrochemical energy storage module, providing electrical energy to an end user.

Stored electrical energy modules, or power units of various types are becoming increasingly common in many applications, in particular for use where there are environmental concerns relating to emissions in sensitive environments, or public health concerns. Stored electrical energy power units are typically used to provide electrical energy to operate equipment, to avoid emissions at the point of use, although that stored energy may have been generated in many different ways. Stored electrical energy may also be used to provide peak shaving in systems otherwise supplied from the grid, or from various types of power generation system, including diesel generators, gas turbines, or renewable energy sources. Aircraft, vehicles, vessels, offshore rigs, or rigs and other powered equipment in remote locations are examples of users of large scale stored electrical energy. Vehicle drivers may use the stored energy power unit in city centres and charge from an internal combustion engine on trunk roads, to reduce the harmful emissions in the towns and cities, or they may charge up from an electricity supply. Ferries which carry out most of their voyage relatively close to inhabited areas, or in sensitive environments are being designed with hybrid, or fully electric drive systems. Ferries may operate with stored energy to power the vessel when close to shore, using diesel generators offshore to recharge the batteries. In some countries the availability of electricity from renewable energy sources to use to charge the stored energy unit means that a fully electric vessel may be used, provided that the stored energy units are sufficiently reliable for the distances being covered, with no diesel, or other non-renewable energy source used at all. Whether hybrid, or fully electric, the stored energy units may be charged from a shore supply when docked. The development of technology to achieve stored energy units that are reliable enough for prolonged use as the primary power source must address certain technical issues.

### SUMMARY

In accordance with a first aspect of the present invention, an energy storage module cooling device comprises a welded polymer plastic, composite or thermoplastic housing, the housing comprising at least two injection moulded polymer plastic, composite or thermoplastic housing parts; the housing parts comprising a perimeter; the housing further comprising a thermoplastic film sandwiched between contact surfaces of the perimeters of the at least two housing parts, the contact surfaces of the at least two housing parts and the sandwiched thermoplastic film forming a weld seal between the two housing parts.

For most efficient manufacture, the housing comprises two housing parts, having perimeters that mirror one another, so that a single continuous weld seals the perimeter surfaces and the thermoplastic film. However, in some cases, the housing may need to be manufactured from more than two parts, in which case additional welding steps are needed to form the complete welded housing.

An energy storage module housing may comprise a welded polymer plastic, composite or thermoplastic housing according to the first aspect.

At least one of the injection moulded housing parts may comprise a plurality of cooling channels formed in the surface of the housing part.

Each of the injection moulded housing parts may comprise a plurality of cooling channels formed in the surface of the housing parts and mirroring channels formed in the other housing part, such that when joined together the channels.

A moisture blocking film may be provided between an outer surface of the cooler and a surface of an energy storage device, or battery cell, installed in the energy storage module.

The moisture blocking film enhances electrical insulation.

In accordance with a second aspect of the present invention, an energy storage module cooling system comprises a source of cooling fluid; and a fluid conduit for supplying the cooling fluid to one or more energy storage modules; wherein each energy storage module comprises a module housing according to the first aspect; wherein each energy storage module comprises an energy storage device; at least one surface of each energy storage device being in direct thermal contact with the cooling channels of the module.

The cooler may comprise a serpentine shaped channel coupled to the source of cooling fluid, or a plurality of channels in parallel coupled to the source of cooling fluid.

The polymer plastic may comprise one of polythene, polyamide polypropylene or polyethylene.

The thickness of walls of the cooler channel may be chosen to not exceed 5 mm. The cooling fluid may comprise one of water, or water glycol mixture. Where an optional thermally insulating layer is used, the thermally insulating layer may comprise an inorganic silicate. The thermally insulating layer may have a thickness in the range of 1 mm to 5 mm. The cooling unit, cooling fluid conduit and coolers, may comprise a closed, re-circulating system. The energy storage devices may comprise electrochemical cells.

In accordance with a third aspect of the present invention, a power supply system may comprise one or more energy storage modules, each module comprising a plurality of energy storage devices electrically connected in series; and a cooling system according to the second aspect.

In accordance with a fourth aspect of the present invention, a method of assembling an energy storge module cooling device according to the first aspect comprising a polymer plastic, composite or thermoplastic housing, the method comprising injection moulding two or more polymer plastic, composite or thermoplastic housing parts; aligning two or more housing parts to be joined; applying heat from a heat source, to heat surfaces of the two or more housing parts to be joined; removing the source of heat; inserting a thermoplastic film between the surfaces to be joined; bringing the heated surfaces into contact with the thermoplastic film, to sandwich the film between the heated surfaces; and allowing the film and housing parts to cool, forming a weld across them.

The step of applying heat from the heat source may comprise one of infra-red heating from an infrared heat source, ultrasonic heating from an ultrasonic heat source, or induction welding from an induction welding heat source.

In accordance with a fifth aspect of the present invention, a method of manufacturing an electrical energy storage module comprises carrying out the method of assembling of the fourth aspect; inserting an energy storage device on one surface of the welded housing; and fitting a further welded housing over the energy storage device to contain the energy storage device.

A method of manufacturing an energy storage unit, the method comprising stacking a plurality of energy storage modules formed according to the fifth aspect, together; and mechanically and electrically connecting the modules together to form an energy storage unit.

### BRIEF DESCRIPTION OF THE DRAWINGS

An example of cooling device and method according to the present invention will now be described with reference to the accompany drawings in which:

FIG. 1 illustrates a cooling system in which a cooling device according to the present invention for a modular stored energy system may be used;

FIGS. 2a and 2b illustrate more detail of the cooling device for energy storage devices using the cooling system according of FIG. 1;

FIGS. 3a and 3b show more detail of the cooling device which may be used in the examples of FIGS. 1, 2a and 2b;

FIG. 4 illustrates how multiple energy storage device cooling devices may be stacked together in the cooling system incorporating the cooling device according to the present invention;

FIG. 5 shows more detail of one embodiment of part of the stack of FIG. 4;

FIGS. 6a, 6b, 6c, 6d, and 6f illustrate an example of a method of manufacturing a housing according to the present invention;

FIG. 7 illustrates more detail of the housing of the present invention; and

FIG. 8 is a flow diagram illustrating the manufacturing process of the present invention.

### DETAILED DESCRIPTION

Electrical energy storage modules based on electrochemical cells, such as batteries are already in use, for example in hybrid, or electric vehicles. Early large scale batteries were lead acid, but more recently, lithium ion batteries have been developed for electrical energy storage for large scale applications. Li-ion batteries are typically pressurised and the electrolyte is flammable, so they require care in use and storage. A problem which may occur with Li-ion batteries is thermal runaway, which may be caused by an internal short circuit in a battery cell, created during manufacture. Other causes, such as mechanical damage, overcharge, or uncontrolled current may also cause thermal runaway, but the battery system design is typically adapted to avoid these. Manufacturing issues with the cells cannot be ruled out entirely, so precautions are required to minimise the effect should thermal runaway occur. In a large scale Li-ion battery system, the amount of energy that is released during a thermal runaway is a challenge to contain. A thermal event may increase temperatures in a single cell from a standard operating temperature in the range of 20° C. to 26° C. to as much as 700° C. to 1000° C. Safe operating temperatures are below 60° C., so this is a significant problem. There are strict regulations in the marine and offshore industries regarding risk to the vessel or rig, one requirement being that there should be no transfer of excess temperature from one cell to another. If overheating occurs, then it should be contained in a single cell and not allowed to spread. In addition, for marine and offshore applications, weight and volume of any equipment is severely restricted, leading to compact, lightweight systems being preferred. It is a challenge to produce a compact, lightweight, system that achieves the required thermal isolation and cools the cell in which excess heating occurs, quickly and efficiently. Another problem is that in a thermal event there may also be release of a large amount of flammable gasses, which may self-ignite at elevated temperatures

The problem may be addressed by allowing whole modules to enter thermal runaway and simply control the resulting flames and fire with an external fire extinguishing system. In this case there are open flames in the battery space and controlling the resulting flames and fire does not ensure safe transportation and storage. A conventional approach is to use thick aluminium fins between each cell to provide the cooling, as the aluminium has good thermally conductivity and is able to conduct heat away effectively, but this adds weight and volume and still does not ensure safe transportation and storage because heat is conducted extremely well through aluminium (>300 W/mK) and will heat neighbouring cells quickly, if not cooled. During transport and storage, cooling may not be available. The problem of release of flammable gas may be handled by providing a pressure valve in the module casing, releasing the gas at a certain pressure, either into the battery space or into a separate exhaust system. However, conventional pressure release valves are designed to burst under pressure, which leads to other problems. In addition, active cooling may be provided in the exhaust outside the module to avoid self-ignition.

In a Li-ion battery system, it is very important that the temperature of the battery cells does not exceed the prescribed operating temperature and that the cell temperature in the entire system is uniform. Sustained operation outside the prescribed operating temperature window may severely affect the lifetime of the battery cells and increases the risk of thermal runaway occurring. The present invention addresses the problem of preventing thermal runaway from spreading to other cells, should it occur in one cell, as well as helping to increase the operating lifetime of a cell.

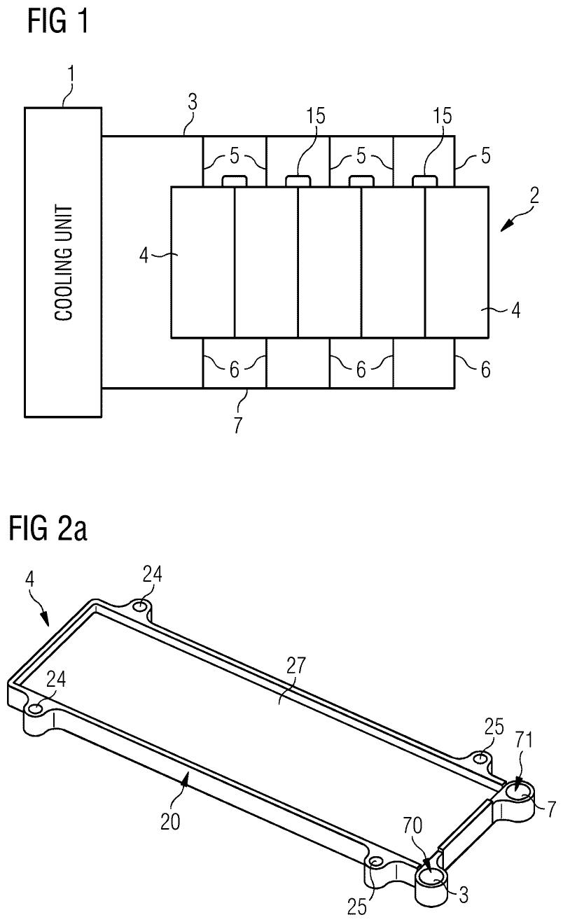

FIG. 1 illustrates one example of a stored electrical energy module cooling system according to the invention. A cooling unit 1 provides a cooling fluid to modules of an energy storage unit 2 via pipes 3. In this example, the energy storage unit comprises a plurality of modules 4, each module supplied in parallel with cooling fluid through inlet tubes 5. Alternatively, cooling fluid may be supplied to each module in series. The warmed cooling fluid is removed through outlet tubes 6 and returned to the cooling unit 1 in pipes 7. Typically, the warmed fluid is cooled again in the cooling unit and re-circulated in a closed system.

An energy storage module 4 typically comprises one or more energy storage devices (not shown), for example electrochemical cells, or batteries, each device being mounted on a carrier, the carrier typically comprising an integral cooler, although it may be possible to provide the cooler separate from the carrier. Energy storage devices are electrically connected together in series with a neighbouring energy storage device on the next cooler, or groups of cells may be electrically connected together in parallel, with multiple groups connected together in series. Forming groups of energy storage devices by parallel connection is another way to reduce the number of PCBs needed.

A module typically comprises between 10 and 30 cells, although more or fewer cells per module are possible, according to the application. The module may further comprise a substantially gas tight enclosure, a part of which comprises a non-magnetic material. The cells are preferably prismatic or pouch type cells to get a good packing density. A plurality of energy storage modules may be connected together in series by a DC bus 15 to form an energy storage unit 2, or cubicle. A single cell of a module may have a capacity between 20 Ah and 100 Ah, more commonly between 60 Ah and 80 Ah, although cells with a capacity as low as a couple of Ah, or over 100 Ah, may be used. In one example, there may be up to thirty energy storage devices per module 4 and up to nine modules per cubicle. Typically, the unit comprises between 9 and 21 modules, although this depends upon the application and may be up to 30, or 40, or as many as 50 modules per cubicle in some cases. Multiple cubicles may be installed on a vessel, or platform, or in any other installation.

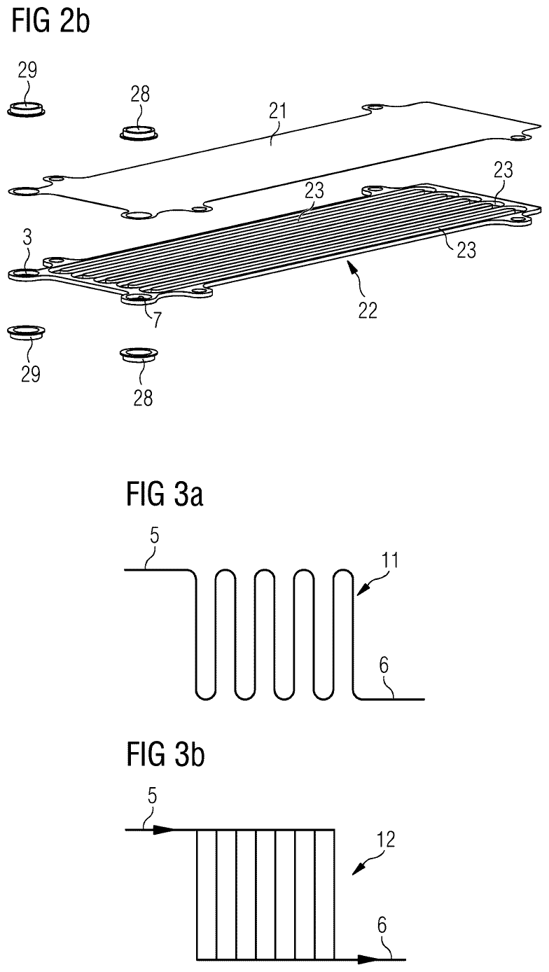

FIGS. 2a and 2b show more detail of the modules 4. Each module comprises a cooler on which an energy storage device (not shown) may be mounted. The cooler may be integral with, or separate from a carrier, or casing 20, as shown in FIG. 2a, into which an energy storage device (not shown), such as a battery cell, is fitted. The carrier is typically made from a polymer plastics material for light weight and low cost. As shown in FIG. 2b, the cooler may be formed by laminating, or welding, a plate 21 to a series of raised sections 23 formed, typically by moulding, in another piece of the same polymer plastics material. This forms closed channels, or conduits, through which cooling fluid may flow from one end to another. Alternatively, the closed channels may be formed from raised sections in two substantially similar halves, which are brought together and welded along their lengths to create the fluid channels integral with the carrier. An energy storage device, such as a battery cell may be installed in each carrier 20, for example on outer surface 27 of the cooler. The outer surface of the cooler 22 may be in direct contact with one surface of the battery cell to provide effective cooling over a large surface area, without any direct contact of the cooling fluid to the energy storage device, or cell.

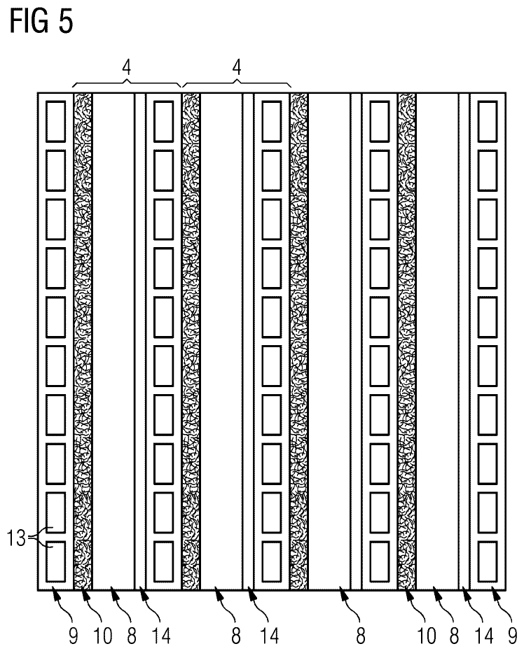

Optionally, another surface of the cell may be provided with a thermally insulating layer, as illustrated in FIG. 5, which shows more detail of a part of a module 4. Each module comprises a plurality of energy storage devices 8, for example, a battery cell, along one side of which is part of the cooler 22 and optionally, on the other side a thermally insulating layer 10 may be provided. The cooler shown provides cooling fluid in the fluid channels to cool by heat exchange over the surface of the cell. The channels are typically thin walled channels or tubing, which may be formed in the carrier by additive manufacturing, moulding, or extrusion and which come into contact with a substantial part of the cell surface. Effective heat transfer from the cell to the cooling fluid is possible through the thin walled conduits.

In order to maintain compression of the cell by the carrier 20 to take account of expansion of the cell over time, there needs to be some flexibility to allow for the changes over time. This may be provided by the thermally insulating layer 10, or by a separate flexible layer 14 provided between one surface of the energy storage device and the cooler. In an example where no thermally insulating layer 10 is used, then the flexible layer 14 may be on only one side, or there may be a flexible layer 14 on both sides of the energy storage device 8. Further improvements to overall performance may be achieved by using a moisture blocking film between the surface of the cooler and energy storage device, or battery cell, for electrical insulation purposes. The insulating layer or flexible sheet applies a low pressure, typically below 0.2 bar, on the cell wall to increase performance and lifespan and accepts swelling due to normal operation and degradation during the complete life of the cell. The carriers 20 are mounted on one another and fixed together via fittings, such as bolts in fittings 24, 25. Between each water inlet section 3 and outlet section 7 on each carrier 20, a spacer, or washer 29, 28 may be provided.

Cooling fluid flows from the inlet pipe 3 through the channels, or conduits 23 of the cooler 22, cooling the cell by thermal transfer from the surface of the cell through the thin tubing 23 to the cooling fluid. The cooling fluid channels or tubing may have a typical overall thickness in the range of 5 mm to 20 mm, with a wall thickness in the range of 1 mm to 5 mm and preferably, no more than 3 mm for a polymer plastics material. The cooling fluid is carried away into the outlet pipe 7 and returned to the cooling unit 1 to be cooled again. The tubing 23 formed under plate 21 covers a substantial part of the cell surface on the side that it contacts, anything from 30% to 75% of the cell surface area on that side of the cell.

The overall design has a significantly reduced total material weight and cost by using the cooling liquid pipes to flow cooling fluid directly adjacent to the cell surface, instead of conventional cooler block, heat exchanger designs. In addition, this cooling is provided for normal operation, to keep the cell within a temperature range that is beneficial to performance and operational lifetime, rather than as a one off, only in the case of a thermal event. The water channels 23 may be formed in any suitable form, connected between the inlet and outlet pipes 3, 7 via the tubes 5, 6. Preferably, the cross section of the channels is square to maximise the contact and minimise the amount of plastics material between the cooling fluid and the energy storage device. However, other cross sections could be used, such as circular cross section tubing. The cell is cooled directly by flowing cooling fluid through the cooling fluid channels in contact with a substantial part of the cell surface, with very little thermal resistance. Conventional cooling arrangements have suffered from hot spots for areas of the cell which were far away from the cooler block, or heat exchanger, but this laminated cooler and cell module avoids this problem. This has the effect of slowing down the aging process of the cell, so increasing its lifetime.

The thin tubing may take any suitable form, connected between the inlet and outlet tubes 5, 6, for example, a continuous serpentine 11 connected between the inlet and outlet tubes 5, 6, as shown in FIG. 3a, or parallel rows 12 of tubing fed by a common supply connected to the inlet tube 5 and exiting through outlet tube 6, as shown in FIG. 3b. The tubing is typically a synthetic material, such as polyethylene, or polyamide, for example PA66 plastics, polypropylene or polyethylene, or thermoplastics such as TCE2, TCE5, or other suitable materials which may be moulded, or extruded to produce the required shape. The tubing material is able to withstand normal operating temperatures of the energy storage modules. The tubing may be formed in two halves of the housing and welded together, or alternatively channel walls are formed on a base, for example by moulding, then a plate is applied to the upper surface of the walls, which is welded, or laminated, or otherwise fixed in place. The conduits for cooling fluid may have an overall thickness in the range of 5 mm to 20 mm, with a wall thickness in the range of 1 mm to 5 mm, preferably, no more than 3 mm for a polymer plastics material.

If used, the layer of thermal insulation 10 on the other side of the cell reduces heat transfer from a cell in the module to a neighbouring cell in the module of the energy storage unit 2 if the cooler is only in direct contact with the cell on one side. The cooling unit 1 provides a flow of cooling fluid around a circuit via pipes 3, 7 and inlet and outlet tubes 5, 6 of each energy storage module 4 then through the conduits 13 of coolers 9 of each energy storage device, or cell 8. Each module 4 is constructed by assembling a series of carriers incorporating the cooler, with a cell, insulation material, a thin flexible sheet to allow for cell expansion, if required, then repeating for multiple cells. The carriers of each cell connected in series provide the fluid supply pipes 3, 7 and are fixed together, for example by bolts running the length of the module through multiple carriers.

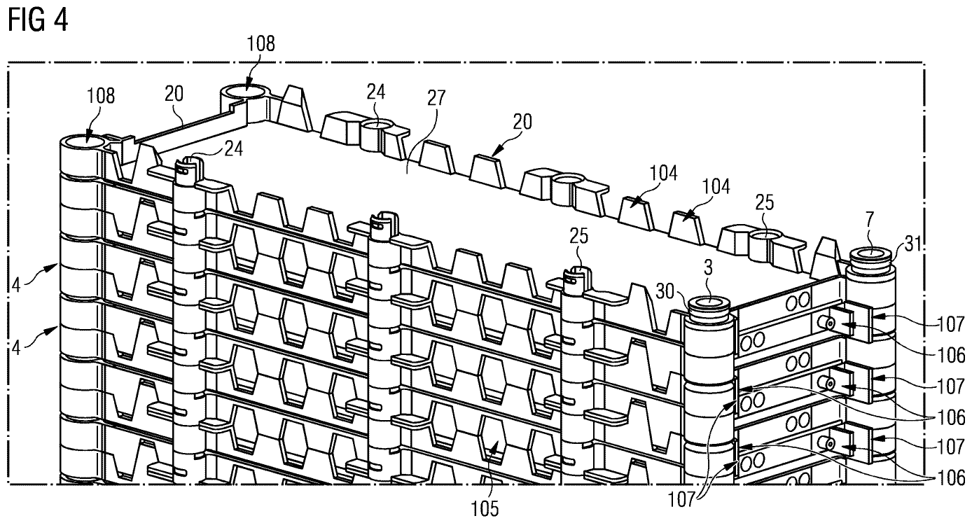

FIG. 4 shows more detail of how the carriers 20 are combined to form a module. For each energy storage device of the module a carrier is provided, each carrier comprising an integral cooler 22 formed between two halves of the carrier, and the carriers are stacked together, as shown in FIG. 4. On an upper surface 27 of each carrier, an energy storage device, such as a lithium ion battery cell (not shown) may be installed. The side fittings at the bottom of one carrier, fit into corresponding fittings 24, 25 at the top of the carrier onto which that carrier has been stacked, to provide mechanical connections to hold the carriers in the stack. The side walls of each carrier may be formed with crenelated features 104 which when two carriers are mounted together produce corresponding openings 105 in the wall to allow air flow around the battery. Cooling fluid enters the tubes of each cooler 22 from an opening 70 in the common inlet pipe 3 that runs along the stack and exits through an opening 71 in the common outlet pipe 7 that runs along the stack. In a closed system, the cooling fluid is pressurised and circulates around the stack of modules via the common pipes 3, 7 and individual coolers 22 of each module 4. On one or more sides of the carriers, printed circuit boards are installed into snap fit components 106. However, automating this assembly is difficult due to the relatively small size and tolerances for the fit. To improve the success rate for automated assembly, additional guides 107 are provided outside the snap fit components 106. These also reduce the likelihood of the PCBs being vibrated out of position during shock and vibration testing.

The combination of water cooling to keep each cell at a preferred operating temperature with the use a light, compact, thermal insulation between individual cells of each module in the energy storage system to prevent propagation of heat from one cell to another results in an energy storage system which is more temperature stable and less prone to thermal runaway. The system may be operated without the need for any complex control system. The addition of the thermal insulation to inhibit transmission of heat between cells in the event of thermal runaway is achievable at a relatively low cost. The user is able to operate the energy storage system within an optimal temperature window, whilst reducing the possibility that, for an electrochemical cell, a thermal event in a module will develop into a thermal runaway.

However, the demand for increased operating lifetimes and enhanced reliability over that time means that further improvements are needed. As mentioned hereinbefore, the cooling channels are typically formed by welding two polymer plastic sections, which may have been moulded, extruded, or formed by additive manufacturing techniques or otherwise, resulting in two shaped halves that must be joined together, e.g. by welding, or one part formed as channels with an open top, onto which a sheet is laminated or welded. In either case, where a polymer plastic cooler is injection moulded in two halves and then the two halves are welded together, the strength of the weld may not be sufficient for the extended periods of operation that customers now require, so it is desirable to be able to make a stronger join between the two parts of the material. One option to increase the strength of the join is to use a different material to form the halves that will have an inherently stronger bond, but that cannot be done at the cost of using a material that does not also have sufficiently good electrical resistance.

For example, where a thermoplastic, such as polypropylene, or polyethylene is used for the cooling housing material, the housing itself may be made stronger for the same thickness or weight, by including fibreglass reinforcement. However, such reinforcement does not contribute to the strength of the weld and may even result in a lower strength weld than is present in a purer material without strengthening or fillers. Another form of strengthening is to choose a material that has cross linking, rather than separate molecules in its structure. However, where the coolers are manufactured using injection moulding of the material to form the channels, the additional strength given by the cross linking effect is not maintained if the cross linked material is subsequently melted, for example by welding the two plastic or composite cooler halves together. Thus, even choosing a stronger base material for the two halves may result in a weld with a lower weld strength after welding.

In order to address this problem and to be able to continue to manufacture the coolers in two parts and subsequently weld them together, but improve the lifetime of the manufactured article by improving the weld strength, an improvement comprises applying a thin film of strengthening material between the weld surfaces of the two parts before carrying out the welding step to bond the two housing parts. This strengthening material may be, for example, a thermoplastic material including cross linkable components, or a polymer, such as polypropylene, polyethylene, or low density polyethylene (PELD), with cross linkable radicals. The cross linkable radicals in the thin film which is inserted between the heated weld pieces (the two parts that are to be welded to each other) will cause cross linking of the material in the weld zone, so that when the two parts are pressed together, a stronger bond results.

The film is chosen to be thin enough to be molten when the film comes into contact with the weld pieces, melting from the heat of the already molten parts of the cooler housing which have first been heated using a suitable technique. When those weld pieces are pressed together with the film between them the heat activates the radicals in the film, for example, a peroxide formulation, such as hydrogenperoxide, other peroxides, tuned to different base material, a dialkyl peroxide, or a proprietary bifunctional organic peroxide, such as BIPB 40 from MPI Chemie, or other suitable source of radicals. The process or material properties may be optimised by using coagents together with the peroxides. The radicals cause crosslinking of the material in the weld zone. To achieve the cross linking, the temperature of the molten material of the thin film must be sufficiently high, typically in the range of 110° C. and 180° C. Example of weld methods that could be used include infra-red welding, ultrasonic welding, laser welding, or hot plate welding. For ultrasonic or laser welding, the thin film is placed in the weld area before the heating step. For infra-red welding, or hot plate welding, the thin film is placed after the housing parts have been heated.

The use of the thin film thermoplastic insert also makes it possible to weld thermoplastic or polymer plastic with high filler content, so the coolers can be moulded or formed from a thermoplastic material, or polymer plastic material, that is in itself stronger than had been used before. Superior weld strength than was previously possible may be achieved compared to direct welding of the strengthened thermoplastic. This reduces the overall size and weight of the manufactured battery modules because each welded housing or cooler for the energy storage device, for example, lithium-ion cells, now has a thinner wall thickness. Use of the thin film insert overcomes the problems of injection moulding formation of thermoplastic including cross linkable elements by only including the cross linkable radicals in the insert and not in the previously moulded thermoplastic weld pieces that are to be joined.

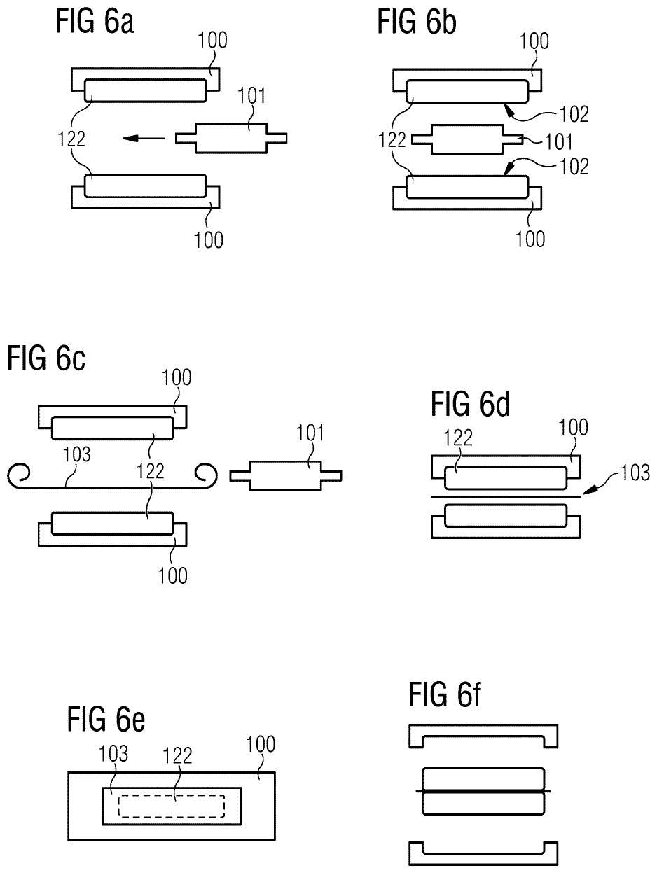

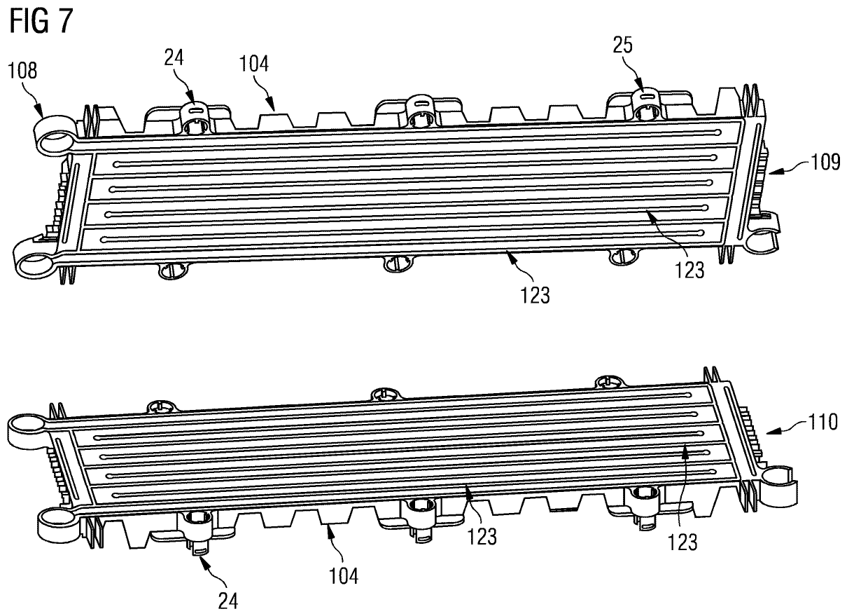

The present invention addresses this problem of how to strengthen the join between the two halves of injection moulded materials by making use of an additional insert of strengthening material, such as a cross linkable material, the cross linking being caused to take place as part of the welding step of the two injection moulded halves. FIGS. 6a to 6f illustrate an example of the method of the present invention. Two housing parts 122 are formed by injection moulding and securely fitted to holders 100 for the welding step. In this example, the housing parts 122 both comprise channel sections (not shown) and the housing parts are aligned such that when joined, the channels formed in each half, line up to form a single channel. More detail of the channels can be seen in FIG. 7. For the example of infra-red welding, an infra-red welding element 101 is moved into position between the two housing parts 122 in their holders 100, as shown in FIG. 6b, so that the heat from the element 101 is transferred to the exposed join surfaces 102 of the housing parts 122, After heating exposed surfaces 102 sufficiently to melt the housing to a desired depth, the welding element 101 is moved away and a strengthening film 103 is moved in place between the molten surfaces 102, as shown in FIG. 6c. Typically, the film is chosen to be wider than the two parts to ensure that the full surface width benefits from the strengthening material in the weld. The film may be mounted on a spool and cut to size before the spool and remaining film is moved out of the gap between the surfaces, as indicated in FIGS. 6d and 6e, so that the two molten halves are moved into contact with the film sandwiched between them. The heat from the molten surfaces 102 is transferred into the thin film 103, causing the film to melt and cross linking of radicals in the thin film material to take place. The strengthening material goes in between each half, whilst the halves are still hot and then they are brought together to weld and incorporate the crosslinked material for strength. This has the effect of forming a centreline sheet through the cooling channels, which may be purged from the channels, after the weld has been completed and the parts have been removed from the holders, as shown in FIG. 6f, or the film in the channels may be left in place, so that in use, the cooling water flows along channels formed either side of the film 103. In the alternative embodiment, where channels are only moulded in one side and a plate is used to form the final wall of the channel, the plate and thin film form a substantially integral wall after the steps of melting the housing part exposed surfaces and applying pressure to the two parts with the film between them.

The application of the strengthening thin film material 103 may be from a spooled roll, using the heat and pressure during the welding step of FIG. 6d to provide a cutting effect to cut the section that is formed into the module housing, or else a separate cutter, such as a knife, or laser cutter, is used to cut the sheet to the required length. In practice, the effect of applying a thin film material 103 to a section of the housing 122 that has been heated is to extend the cross linking into the partially molten material of the housing, as well as the film. This helps the different layers adhere correctly. Suitable materials for the thin film include low density polyethylene (PELD), with ozone as the cross linking part, or cross linkable PVC, such as used in water pipes. This thin film material 103 in combination with, for example, a polypropylene housing 122, which has good electrical insulation and low water absorption properties, allows a reliable battery cooler to be constructed, which is suitable for a wide range of voltage both low voltage LV (up to 1500 V DC) and MV (above 1500 V DC). Using electrically insulating materials for the housing ensures that there is sufficient electrical insulation to cope with MV operation. Achieving the same voltage levels with any sort of metallic housing would be extremely difficult.

As can be seen from the example of FIG. 7, each one of the two housing parts 109, 110 has channels 123 formed in it and before welding the two parts together, those channels must be aligned. The strengthening film is inserted between the two parts, effectively closing off the final wall of the channels and sandwiched between the two parts under pressure. The weld formed from the molten film and molten wall surfaces cools and sets and forms a strong bond between the two halves, which is longer lasting than simply welding the moulded surfaces directly to one another.

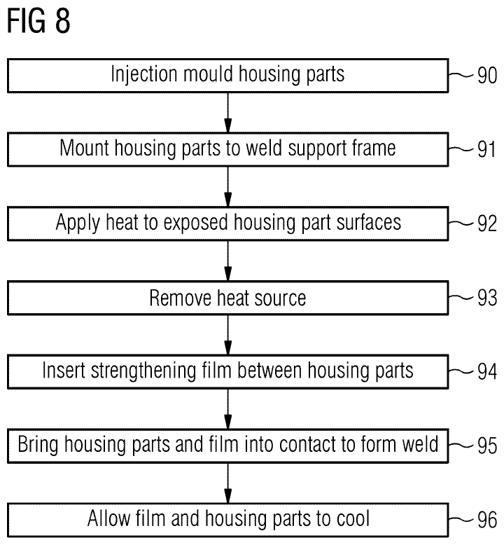

FIG. 8 is a flow diagram showing the steps of a method of assembling a polymer plastic, composite or thermoplastic housing according to the present invention. Two or more polymer plastic, composite or thermoplastic housing parts are injection moulded 90 from the chosen material. The housing parts to be joined are first mounted 91 to a support frame, such that the fluid channels may be aligned when the two halves are brought together for the weld. Heat is applied 92 to the exposed surfaces of each half, that face the other. The heat source is typically a non-contact heat source, heating by radiation, or vibration, or induction.

After heating the surfaces of the two or more housing parts to be joined, the source of heat is removed 93 and a strengthening film, such as a PELD film or thermoplastic film, is inserted 94 between the surfaces to be joined. This may be done by running the film on a spool and cutting to size when in position, or relying on the heat and pressure when the two parts are brought together to cut away excess film outside the join area. The heated surfaces of the two housing parts are brought into contact 95 with the thermoplastic film and sandwich the film between the two heated surfaces. Thereafter, the film and housing parts are allowed to cool 96, forming a weld across them.

The step of applying heat 92 from the heat source may comprise one of infra-red heating from an infrared heat source, ultrasonic heating from an ultrasonic heat source, or induction welding from an induction welding heat source. To manufacturing an electrical energy storage module, the same method as described above is carried out before locating an energy storage device on one surface of the welded housing 20. A further welded housing 20 is then fitted over the energy storage device to contain the energy storage device and held in place by mechanical fittings 24, 25. An energy storage unit may then be formed by stacking together a plurality of energy storage modules formed according to the aforementioned method. Each module in the stack is mechanically and electrically connected together to form the energy storage unit.

Although the examples have been described with respect to electrochemical cells, such as batteries, which may suffer a thermal runaway and the need to prevent this propagating, other types of stored energy units, such as capacitors, supercapacitors, and fuel cells may suffer if the temperature of modules of the stored energy units regularly goes outside a preferred operating range, reducing the overall lifetime and increasing maintenance costs, so the cooling system may also be beneficial for these. For a vessel, or system, relying on stored energy as its primary, or only power source, reliability is particularly important and optimising operating conditions is desirable. The detailed examples given are for batteries, or electrochemical cells, but the principle of the invention is applicable to other types of energy storage unit.

1. A housing comprising at least two injection moulded polymer plastic, composite or thermoplastic housing parts; the housing parts comprising a perimeter; the housing further comprising a thermoplastic film sandwiched between contact surfaces of the perimeters of the at least two housing parts, the contact surfaces of the at least two housing parts and the sandwiched thermoplastic film forming a weld seal between the two housing parts.

2. An energy storage module housing, the housing comprising a welded polymer plastic, composite or thermoplastic housing according to claim 1.

3. The housing according to claim 1, wherein at least one of the injection moulded housing parts comprises a plurality of cooling channels formed in the surface of the housing part.

4. The housing according to claim 1, wherein each of the injection moulded housing parts comprises a plurality of cooling channels formed in the surface of the housing parts and mirroring channels formed in the other housing part, such that when joined together the plurality of cooling channels are formed.

5. The housing according to claim 1, wherein a moisture blocking film is provided between an outer surface of a cooler and a surface of an energy storage device, or battery cell, installed in an energy storage module.

6. An energy storage module cooling system, the system comprising a source of cooling fluid; and a fluid conduit for supplying the cooling fluid to one or more energy storage modules, the modules comprising the housing according to claim 1; wherein each energy storage module comprises an energy storage device; at least one surface of each energy storage device being in direct thermal contact with cooling channels of the module.

7. The energy storage module cooling system according to claim 6, wherein the cooling channels comprise serpentine shaped channels coupled to the source of cooling fluid; or a plurality of cooling channels in parallel coupled to the source of cooling fluid.

8. The energy storage module cooling system according to claim 6, wherein the polymer plastic comprises one of polythene, polyamide polypropylene or polyethylene.

9. The energy storage module cooling system according to claim 6, wherein the energy storage devices comprise electrochemical cells.

10. A power supply system, the system comprising one or more energy storage modules, each module comprising a plurality of energy storage devices electrically connected in series; and a cooling system according to claim 6.

11. A method of assembling a polymer plastic, composite or thermoplastic housing, the method comprising injection moulding two or more polymer plastic, composite or thermoplastic housing parts; aligning two or more housing parts to be joined; applying heat from a heat source, to heat surfaces of the two or more housing parts to be joined; removing the source of heat; inserting a thermoplastic film between the surfaces to be joined; bringing the heated surfaces into contact with the thermoplastic film, to sandwich the film between the heated surfaces; and allowing the film and housing parts to cool, forming a weld across them.

12. A method according to claim 11, wherein the step of applying heat from the heat source comprises one of infra-red heating from an infrared heat source, ultrasonic heating from an ultrasonic heat source, or induction welding from an induction welding heat source.

13. A method of manufacturing an electrical energy storage module, the method comprising carrying out the method of assembling of claim 11; inserting an energy storage device on one surface of the welded housing; and fitting a further welded housing over the energy storage device to contain the energy storage device.

14. A method of manufacturing an energy storage unit, the method comprising stacking a plurality of energy storage modules formed according to the method of claim 13 together; and mechanically and electrically connecting the modules together to form an energy storage unit.
